(19) United States
(12) Patent Application Publication
(10) Pub. No.: US 2010/0186206 A1
(43) Pub. Date: Jul. 29, 2010

(54) MINIATURE MEMORIALS

(76) Inventor: STANLEY E. SULENSKI, Holyoke, MA (US)

Correspondence Address: MCCORMICK, PAULDING & HUBER LLP, CITY PLACE II, 185 ASYLUM STREET, HARTFORD, CT, 06103, US

(21) Appl. No.: 12/359,437

(22) Filed: Jan. 26, 2009

(51) Int. Cl. A61G 17/00; G09F 19/00

(52) U.S. Cl. 27/1; 40/124.5

(57) ABSTRACT

Miniature memorials are provided which are light in weight and of small size so as to be easily portable by hand, the memorials being inscribed with the name and vital dates of a deceased loved one and being readily positioned for prominent display in a place of honor for open viewing or moved to any selected location for keeping alive the memory of the deceased while displaying any one of miscellaneous items such as a cross, or a crucifix, or other religious, or military or national items intimately associated with the deceased.

### FIELD OF THE INVENTION

The present invention relates, generally, to memorials and more particularly to memorials for commemorating deceased loved ones that are of a size and construction so as to make in-home display of the memorial possible.

### BACKGROUND OF THE INVENTION

In many Roman Catholic funerals it is part of the burial rite for the priest to present to the surviving spouse or one of the surviving children of the deceased the crucifix, which was present on the coffin. While this crucifix is forever linked to the deceased, it is often stored away in a drawer or box following the funeral and forgotten.

Similarly, items representing other religions such as a Latin cross, or the Star of David, or the military service or national origin of the deceased which were of significance to the deceased may become lost.

Permanent memorials such as gravestones or the like cannot be moved, are often not readily accessible, or are located far from the home of the survivors.

A pressing need exists for memorials which are light in weight and small in size so as to be easily portable by hand, the memorials being inscribed with the name and vital dates of the deceased and being readily positioned for prominent display in a place of honor for open viewing or moved to any selected location for keeping alive the memory of the deceased all while displaying selected ones of miscellaneous items such as a cross, or a crucifix, or other religious, or military, or national items or insignia intimately associated with the deceased and of great importance or significance to him or her.

### SUMMARY OF THE INVENTION

It is a primary object of the invention to provide miniature memorials which are light in weight and of small size so as to be easily portable by hand, the memorials being inscribed with the name and vital dates of a deceased loved one and being readily positioned for prominent display in a place of honor for open viewing or moved to any selected location for keeping alive the memory of the deceased while displaying miscellaneous items such as a cross, or a crucifix, or other religious or military or national items or insignia intimately associated with the deceased.

### BRIEF DESCRIPTION OF THE DRAWINGS

FIG. 1 is a front elevational view of a miniature memorial embodying the invention and displaying a Latin cross;

FIG. 2 is a front perspective view of a miniature memorial of embodying the invention and displaying a crucifix;

FIG. 3 is a front perspective view of a miniature memorial embodying the invention and displaying a banner carrying a Star of David symbol; and

FIG. 4 is a front perspective view of a miniature memorial embodying the invention and displaying the flag of the United States of America.

### DETAILED DESCRIPTION OF THE PREFERRED EMBODIMENT

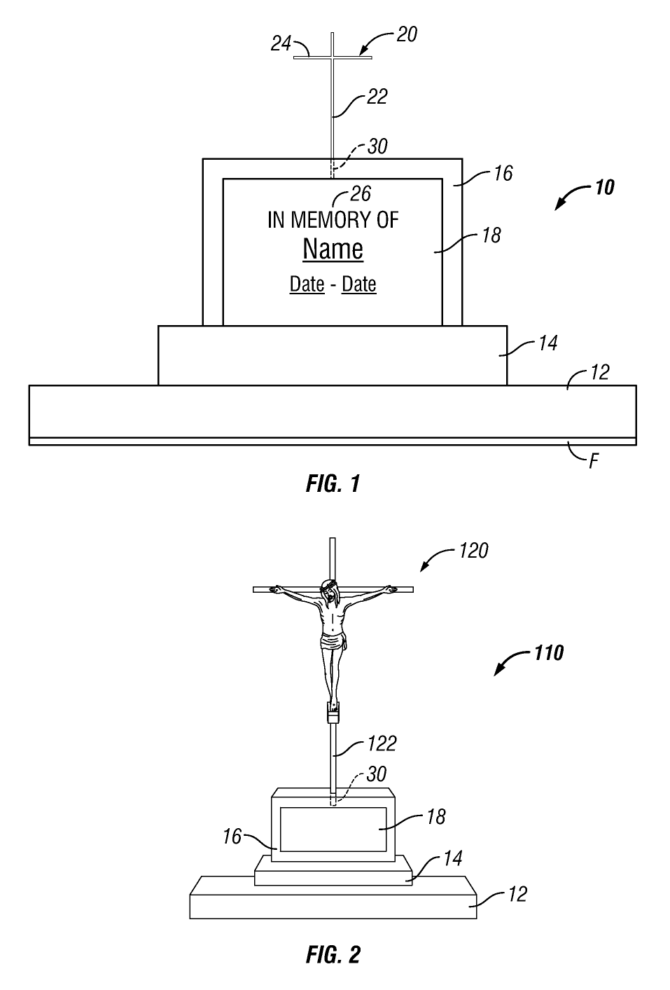

Referring first to FIG. 1, a miniature memorial 10 illustrating one embodiment the present invention includes a foundation 12, a base 14, a headstone 16, a memorial plaque 18 and a Latin cross 20 having the usual right angularly disposed vertically upright member 22 and upper cross member 24.

Memorial 10 is preferably of small size and low weight so as to be readily portable by hand, with the foundation, base and headstone being fabricated from white Italian marble, or any other appropriately light weight stone, or wood, or plastic materials.

The foundation and base are both horizontally disposed and rectangular in plan and form a stepped structure with the base 14 being smaller in length and width than the length and width of foundation 12, while both are of approximately the same thickness. The foundation and base may be formed as an integral structure of may be formed separately with the base fixed to the upper face of the foundation by any suitable fastening means. A felt pad F may be fixed to the lower face of foundation 12 to protect against marring of tabletops or other surfaces on which the miniature memorial may be placed.

Headstone 16 is generally rectangular in front elevation and is fixed to and extends vertically upwardly from base 14 adjacent the rear edge thereof, with the length of the headstone being less than that of base 14 to further enhance the stepped appearance of memorial 10.

Memorial plaque 18 is fixed to the face of headstone 16 and may be fabricated from any bright metal such as gold, silver, brass, or the like. The plaque is engraved as at 26 with the phrase “In memory of” and the name of the deceased and at 28 with the vital dates of birth and death of the deceased. To add a striking feature to the memorial, plaque 18 may be fabricated from black brass, while the letters of the engravings 26 and 28 may be inscribed in gold. For a more traditional setting, plaque 18 may be omitted and the name and vital dates of the deceased inscribed directly on the face of headstone 16.

Latin cross 20 is attached to headstone 16 by inserting the lower end of upright member 22 of the cross into a provided port or opening 30 which is located centrally of the upper horizontal face of the headstone and extends vertically into the body of the headstone.

Cross 20 may be permanently attached to headstone 16 by any suitable means such as an adhesive or by a press fit between the upright member 22 and port 30. Alternatively, the port 30 may have threads inscribed therein, so as to threadedly engage with watching threads formed on the cross 20.

In the miniature memorial 110 as shown in FIG. 2, a crucifix 120 is substituted for Latin cross 20, with the lower end of an upright member 122 of the crucifix being inserted into port 30 of headstone 16 and permanently attached to the headstone by any suitable means such as an adhesive or by a press fit between upright member 122 and port 30. The other components of miniature memorial 110 remain the same as those of miniature memorial 10 of FIG. 1 and are light in weight and small in size so that the memorial is readily portable by hand.

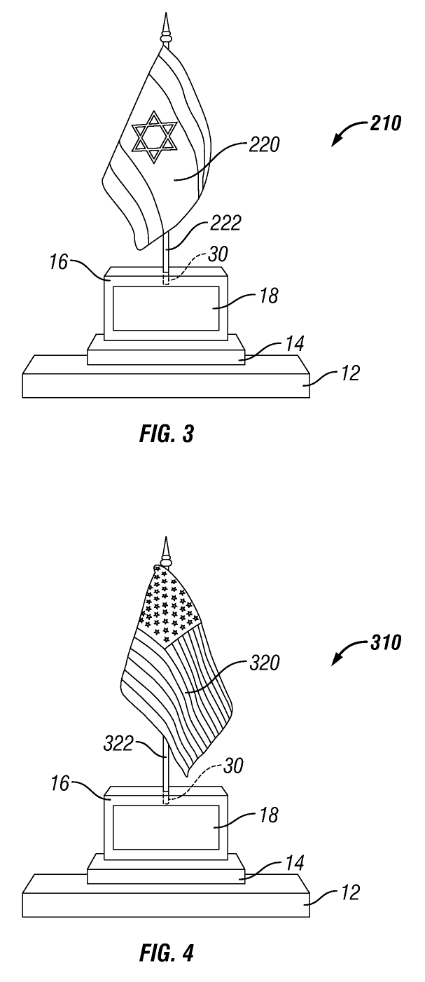

In the miniature memorial 210 as shown in FIG. 3, a banner 220 having a Star of David imprinted thereon is substituted for Latin cross 20, with the lower end of an upright member 222 which supports the banner being inserted into port 30 of headstone 16 and permanently attached to the headstone by any suitable means such as an adhesive or by a press fit between upright member 222 and port 30. The other components of miniature memorial 210 remain the same as those of miniature memorial 10 of FIG. 1 and are light in weight and small in size so that the memorial is readily portable by hand.

In the miniature memorial 310 as shown in FIG. 4, a flag 320 of the United States of America is substituted for Latin cross 20, with the lower end of an upright flag pole 322 which supports the flag being inserted in port 30 of headstone 16 and permanently attached to the headstone by any suitable means such as an adhesive or by a press fit between upright flag pole 322 and port 30. The other components of miniature memorial 310 remain the same as those of miniature memorial 10 of FIG. 1 and are light in weight and small in size so that the memorial is readily portable by hand.

It will be readily apparent from the foregoing that miniature memorials are provided which are of small size and are fabricated from low weight materials so as to be readily portable by hand and which may be appropriately modified to display a wide variety of religious, military, national, or other items intimately associated with a deceased loved one, with the memorials being easily moveable from place to place for keeping alive the memory of a deceased loved one.

What is claimed is:

1. A miniature memorial which is light in weight and of small size so as to be easily portable by hand, the memorial being readily positionable for prominent display in a place of honor for open viewing and moveable to any selected location for keeping alive the memory of a deceased loved one comprising:
a headstone;
the headstone bearing the name and vital dates of the deceased thereon; and
means on the headstone for displaying any one of miscellaneous items intimately associated with the deceased.

2. A miniature memorial according to claim 1, wherein the name and vital dates of the deceased are inscribed on a plaque affixed to the headstone.

3. A miniature memorial according to claim 2, wherein the plaque is fabricated from black brass and the name and vital dates of the deceased are inscribed thereon in gold lettering.

4. A miniature memorial according to claim 1, wherein the means on the headstone for displaying the miscellaneous items is a port adapted to receive support members carrying said miscellaneous items.

5. A miniature memorial according to claim 4,including means for permanently securing said support members in said port.

6. A miniature memorial according to claim 1, wherein one of the miscellaneous items is a Latin cross.

7. A miniature memorial according to claim 1, wherein one of the miscellaneous items is a crucifix.

8. A miniature memorial according to claim 1, wherein one of the miscellaneous items is a banner.

9. A miniature memorial according to claim 8, wherein the banner carries a Star of David symbol.

10. A miniature memorial according to claim 1, wherein one of the miscellaneous items is a national flag.

11. A miniature memorial according to claim 10, wherein the national flag is the flag of the United States of America.

12. A miniature memorial according to claim 1, wherein the headstone is mounted on a stepped base and foundation.

13. A miniature memorial according to claim 12, wherein the headstone, base and foundation are fabricated from white Italian marble.

14. A method of creating a miniature memorial which is readily positionable for prominent display in a place of honor for open viewing and moveable to any selected location for keeping alive the memory of a deceased loved one comprising:
selecting a headstone which is light in weight and of small size so as to be easily portable by hand;
inscribing the name and vital dates of the deceased on the headstone; and
providing means on the headstone for displaying any one of miscellaneous items intimately associated with the deceased.

15. A method of creating a miniature memorial according to claim 14, wherein the name and vital dates of the deceased are inscribed on a plaque attached to the headstone.

16. A method of creating a miniature memorial according to claim 15, wherein the plaque is fabricated from black brass and the name and vital dates of the deceased are inscribed thereon in gold lettering.

17. A method of creating a miniature memorial according to claim 14, wherein the means on the headstone for displaying any one of said miscellaneous items intimately associated with the deceased is a port adapted to receive support members carrying said miscellaneous items.

18. A method of creating a miniature memorial according to claim 17, including means for permanently securing said support members in said port.

19. A method of creating a miniature memorial according to claim 14, wherein the headstone is mounted on a stepped base and foundation.

20. A method of creating a miniature memorial according to claim 14, wherein any one of the miscellaneous items is selected from one of a Latin cross, a crucifix, a banner carrying a religious or military symbol or a national flag.
